(19) United States
(12) Patent Application Publication
(10) Pub. No.: US 2009/0199575 A1
(43) Pub. Date: Aug. 13, 2009

(54) BOIL OFF GAS MANAGEMENT DURING SHIP-TO-SHIP TRANSFER OF LNG

(75) Inventor: Solomon Aladja Faka, Woodland Hills, CA (US)

Correspondence Address: EDELL, SHAPIRO & FINNAN, LLC, 1901 RESEARCH BOULEVARD, SUITE 400, ROCKVILLE, MD, 20850, US

(73) Assignee: WOODSIDE ENERGY LIMITED, Perth (AU)

(21) Appl. No.: 12/399,584

(22) Filed: Mar. 6, 2009

Related U.S. Application Data
(63) Continuation of application No. PCT/AU2007/001316, filed on Sep. 7, 2007.
(60) Provisional application No. 60/843,395, filed on Sep. 11, 2006.

(51) Int. Cl. F17C 9/00; F17C 9/04

(52) U.S. Cl. 62/50.1; 62/53.2; 62/50.3

(57) ABSTRACT

The present invention relates to a process and system for managing boil-off gas generated during ship-to-ship transfer of LNG at sea. The LNG is transferred from a storage tank onboard a delivery vessel to a storage tank onboard a receiving vessel. The process includes the steps of a) operating the receiving vessel storage tank at a pressure greater than the operating pressure of the delivery vessel storage tank; and, b) transferring a portion of the boil-off gas from the receiving vessel storage tank to the delivery vessel storage tank onboard.

### CROSS REFERENCE TO RELATED APPLICATIONS

This application is a continuation of PCT/AU2007/001316, filed Sep. 7, 2007, and titled “Boil Off Gas Management During Ship-To-Ship Transfer of LNG,” which claims priority to U.S. Provisional Patent Application Ser. No. 60/843,395, filed on Sep. 11, 2006, the entire contents of which are hereby incorporated by reference.

### FIELD OF THE INVENTION

The present invention relates to a process and a system for managing boil-off gas generated during ship-to-ship transfer of LNG at sea, the LNG being transferred from a storage tank onboard a delivery vessel to a storage tank onboard a receiving vessel.

### BACKGROUND TO THE INVENTION

Natural gas is the cleanest burning fossil fuel as it produces less emissions and pollutants than either coal or oil. Natural gas (“NG”) is routinely transported from one location to another location in its liquid state as “Liquefied Natural Gas (“LNG”). Liquefaction of the natural gas makes it more economical to transport as LNG occupies only about 1/600th of the volume that the same amount of natural gas does in its gaseous state. Transportation of LNG from one location to another is most commonly achieved using double-hulled ocean-going vessels with cryogenic storage capability referred to as LNG Carriers.

LNG is typically stored in cryogenic storage tanks onboard an LNGC, the storage tanks being operated either at or slightly above atmospheric pressure. The majority of existing LNGCs have an LNG cargo storage capacity in the size range of 120,000 m³ to 150,000 m³, with some LNGCs having a storage capacity of up to 264,000 m³. The temperature within an LNG storage tank will remain constant if the pressure is kept constant and vice versa. This phenomenon is referred to in the art as “auto-refrigeration”. Therefore, whilst LNG storage tanks are heavily insulated to limit the amount of LNG that boils off or evaporates, it is standard procedure to release some of the boil off gas is released from the tank or else the pressure and temperature within the tank will continue to rise.

Various processes exist for removal and recovery of the boil off gas. The boil off gas can be compressed, reliquefied and placed back in the storage tanks, or used as fuel for the boilers of the main steam turbine engines used to propel the a traditional prior art LNG carrier. As required by the relevant international code, all LNG vessels are fitted with an alternative means for dealing with excess boil off gas in case there is a failure in the fuel supply or re-liquefactions systems. In some cases, the alternative means is a gas combustion unit which burns the excess boil off gas so that large volumes of un-combusted gas, which could be ignited, are not vented to the atmosphere.

It is well known that boil off gas is generated when LNG is loaded from a storage tank at an export terminal into the storage tanks of an LNG carrier or unloaded from an LNG carrier into the large storage tanks of an onshore import terminal. International Patent Publication Number WO 0061989 describes a method of minimising boil off gas generation during the transfer of low-boiling liquids, including LNG, from a first storage container to a second storage container. The method relies on maintaining a differential pressure of about 10 mbar to 100 mbar, preferably 20 mbar to 50 mbar between the first and second storage containers during the transfer, wherein a higher pressure is set in the storage container into which the LNG is to be supplied. As soon as possible thereafter, this pressure is reduced by removing boil off gas to restore the pressure in the second storage container to atmospheric pressure. The boil off gas is removed by venting, flaring, use as a fuel gas to the steam turbines, or compression and reliquefaction. This method has become standard practice in the LNG industry.

LNG is normally regasified before distribution to end users through a pipeline or other distribution network at a temperature and pressure that meets the delivery requirements of the end users. Regasification of the LNG is most commonly achieved by raising the temperature of the LNG above the LNG boiling point for a given pressure. It is common for an LNGC to receive its cargo of LNG at an export terminal located in one country and then sail across the ocean to deliver its cargo to an import terminal located in another country. Upon arrival at the import terminal, the LNGC berths at a pier or jetty and offloads the LNG as a liquid to an onshore storage and regasification facility located at the import terminal. The regasification facility typically comprises a plurality of heat exchangers or vaporisers, pumps and compressors. Such onshore storage and regasification facilities are typically large and the costs associated with building and operating such facilities are significant.

Recently, public concern over safety of onshore regasification facilities has led to the building of offshore regasification terminals which are removed from populated areas and onshore activities. Various offshore terminals with different configurations and combinations have been proposed. For example, U.S. Pat. No. 6,089,022 described a system and a method for regasifying LNG aboard a carrier vessel before the re-vaporized natural gas is transferred to shore. Seawater taken from the body of water surrounding said vessel is flowed through the vaporizer to heat and vaporize the LNG back into natural gas before the natural gas is off-loaded to onshore facilities. Regasification takes place onboard an LNGC which has been modified so that the regasification facility travels with the LNGC all of the way from the export terminal to the import terminal. The LNG onboard the converted LNGC is regasified and delivered to shore through a subsea pipeline connected by risers to the mooring buoy.

In another example, an offshore regasification terminal is used which includes a non-propelled barge fitted with cryogenic storage tanks. The barge is permanently moored to and able to weathervane around a mooring buoy but cannot travel under its own steam. The barge is typically longer than an LNGC to assist in side-by-side berthing of the LNGC alongside the barge so that the LNG can be offloaded from the LNGC into the storage tanks onboard the permanently moored barge. The barge includes at least one regasification unit which is typically built adjacent to and forward of the storage tanks. Regasified natural gas flows from the barge to shore through a sub-sea pipeline which is connected to the barge through a marine riser connected to the turret mooring buoy.

An object of the present invention is to provide an alternative to traditional LNG operations.

### SUMMARY OF THE INVENTION

According to one aspect of the present invention there is provided a process for managing boil-off gas generated during ship-to-ship transfer of LNG at sea, the process including the steps of:
(a) transferring LNG from a storage tank onboard a self-propelled delivery vessel to a storage tank onboard a self-propelled receiving vessel at a ship-to-ship transfer location whist operating the receiving vessel storage tank at a pressure greater than the operating pressure of the delivery vessel storage tank;
(b) returning a sufficient portion of the boil-off gas from the receiving vessel storage tank to the delivery vessel storage tank to avoid pulling a vacuum; and,
(c) reducing the pressure within the receiving vessel storage tank to a normal operating pressure during regasification of LNG to produce natural gas when the self-propelled receiving vessel transits from the ship-to-ship transfer location to a regasification location closer to shore.

In one form, the receiving vessel storage tank is provided with a tank protection system which includes a pressure monitoring device and a relief valve. When the delivery vessel storage tank has a standard operating pressure in the range of 0 to 0.15 bar above atmospheric pressure, the relief valve provided on the receiving vessel storage tank may be set at 0.2 bar or 0.35 bar or 0.5 bar or 0.7 bar above the standard operating pressure of the delivery vessel storage tank. The receiving vessel storage tank may be a self-supporting, or a membrane or a prismatic tank.

In one form, the receiving vessel has a power generation system and a portion of the boil off gas from the receiving vessel storage tank is used as a source of fuel for the power generation system of the receiving vessel after the ship to ship transfer has been completed. In another form, the delivery vessel has a power generation system and a portion of boil off gas being transferred from the receiving vessel storage tank to the delivery vessel storage tank is used as a source of fuel for the delivery vessel power generation system during ship to ship transfer.

According to a second aspect of the present invention there is provided a system for managing boil-off gas generated during ship-to-ship transfer of LNG at sea, the LNG being transferred from a storage tank onboard a self-propelled delivery vessel to a storage tank onboard a self-propelled receiving vessel, the system comprising:
a receiving vessel storage tank arranged to operate at a pressure greater than the operating pressure of the delivery vessel storage tank;
a return line for transferring a sufficient portion of the boil-off gas from the receiving vessel storage tank to the delivery vessel storage tank to avoid pulling a vacuum; and,
a regasification facility onboard the self-propelled receiving vessel for reducing the pressure within the receiving vessel storage tank to a normal operating pressure during regasification of LNG to produce natural gas when the self-propelled receiving vessel transits from the ship-to-ship transfer location to a regasification location closer to shore.

In one form, the receiving vessel storage tank is provided with a tank protection system which includes a pressure monitoring device and a relief valve. When the delivery vessel storage tank has a standard operating pressure in the range of 0 to 0.15 bar above atmospheric pressure, the relief valve provided on the receiving vessel storage tank may be set at 0.2 bar or 0.35 or 0.5 or 0.7 bar above the standard operating pressure of the delivery vessel storage tank.

In one form, the system further comprises LNG transfer equipment and the return line is integrated with the LNG transfer equipment.

In one form, the receiving vessel has a power generation system and a portion of the boil off gas from the receiving vessel storage tank is used as a source of fuel for the power generation system of the receiving vessel after the ship to ship transfer has been completed. In another form, the delivery vessel has a power generation system and a stream of boil off gas from the receiving vessel storage tank is used as a source of fuel for the power generation system of the delivery vessel during ship to ship transfer.

To cope with the stresses which accompany intermediate fluid levels, it is preferably that the receiving storage tank either eliminates sloshing or is robust to sloshing of the LNG when the storage tank is partly filled. The receiving vessel storage tank may be a self-supporting or a prismatic or a membrane tank.

The receiving vessel may further include a recess disposed within the hull and towards the bow of the receiving vessel for receiving a submersible, disconnectable mooring buoy for mooring the receiving vessel at a regasification location. To reduce environmental impact, the onboard regasification facility preferably uses ambient air as a source of heat. In one form, the LNG is regasified through heat exchange with an intermediate fluid and the intermediate fluid is heated using ambient air as a source of heat to the onboard regasification facility. Heat exchange between the ambient air and the LNG or between ambient air and an intermediate fluid may be encouraged through use of forced draft fans.

In one form, the receiving vessel further comprises an onboard reliquefaction plant for forming LNG from boil-off gas to reduce the pressure in the receiving vessel storage tank after ship-to-ship transfer of LNG.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a schematic plan view of a delivery vessel underway whilst a receiving vessel makes an approach;

FIG. 2 is a schematic plan view of the delivery and receiving vessels of FIG. 1 as the receiving vessel manoeuvres closer to the delivery vessel;

FIG. 3 is a schematic plan view of a first embodiment of the present invention illustrating the delivery and receiving vessels positioned at an ship-to-ship transfer location during transfer of the LNG from the delivery vessel to the receiving vessel, the receiving vessel being fitted with an onboard regasification facility;

FIG. 4 is a schematic plan view of a regasification location and subsea pipeline for delivering gas to an onshore distribution facility; and,

FIG. 5 is a schematic side view of the receiving vessel moored at a turret mooring buoy as the LNG is regasified onboard the receiving vessel and transferred through one or more marine riser(s) and associated sub-sea pipeline(s) to shore.

### DETAILED DESCRIPTION OF PREFERRED EMBODIMENTS

Particular embodiments of a process and system for ship-to-ship transfer of liquefied natural gas (LNG) from a delivery vessel to a receiving vessel at sea are now described. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs.

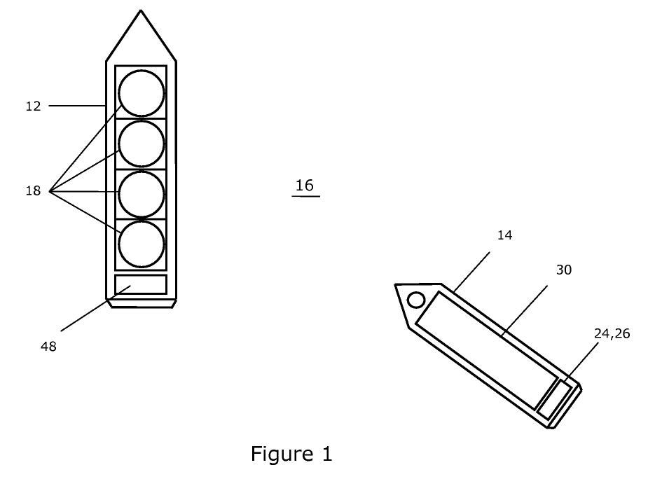

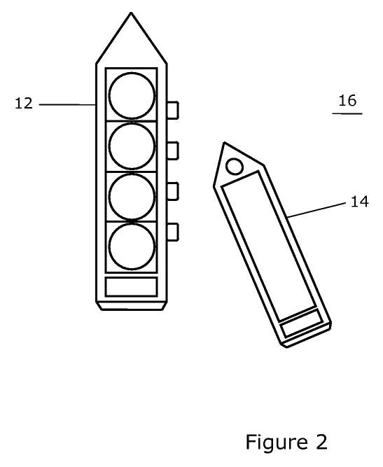

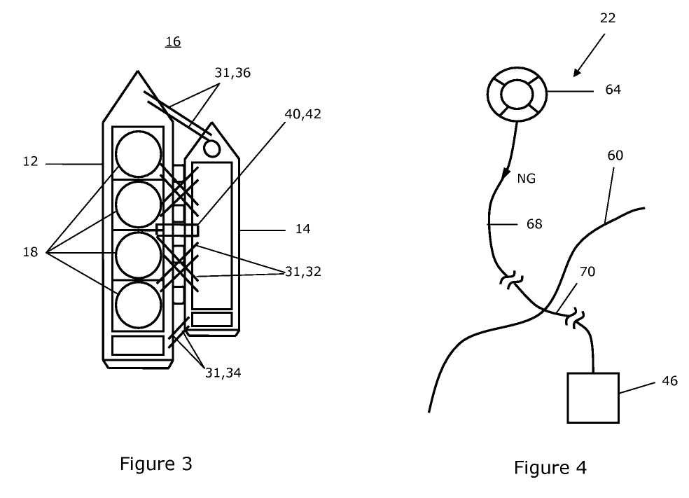

An embodiment of the present invention is now described with reference to FIGS. 1 to 5. In this embodiment, a delivery vessel 12 is loaded with a cargo of LNG at an export terminal (not shown). In this example, the delivery vessel 12 is a traditional LNG Carrier fitted with Moss-style cryogenic storage tanks. The loaded delivery vessel 12 then travels towards an import terminal located typically in a different country to the country of origin where the export terminal is located. Upon arrival, a receiving vessel 14 is dispatched to dock with the delivery vessel 12 at a ship-to-ship transfer location (generally designated by the reference numeral 16) at sea. After the LNG is transferred from the delivery vessel 12 to the receiving vessel 14 at the ship-to-ship transfer location 16, the delivery vessel 12 can sail away back to the export terminal or another location for reloading.

Using the process and system of the present invention, the boil-off gas generated during the ship-to-ship transfer of LNG at sea is managed as the LNG is being transferred from a storage tank onboard a delivery vessel 12 (hereinafter referred to as the delivery vessel storage tank 18) to a storage tank onboard a receiving vessel 14 (hereinafter referred to as the receiving vessel storage tank 20). As described in greater detail below, the process includes the step of operating the receiving vessel storage tank 20 at a pressure greater than the operating pressure of the delivery vessel storage tank 18, as well as the step of transferring a portion of the boil-off gas from the receiving vessel storage tank 20 to the delivery vessel storage tank 18.

The ship-to-ship transfer location 16 can be any location at sea where the delivery and receiving vessels 12 and 14 respectively, can be moored together to facilitate transfer of LNG from the delivery vessel 12 to the receiving vessel 14. The selection of the ship-to-ship transfer location 16 depends on a number of relevant factors including water depth, sea conditions, prevailing winds, regulatory requirements and traffic. The distance of the ship-to-ship transfer location 16 from the coast may vary widely but is preferably outside the territorial sea of the delivery country, at a distance in the range of 12 to 200 nautical miles off the coast.

The receiving vessel 14 can be a modified ocean-going LNG vessel or a vessel that is custom built to include a regasification facility 30. To be economic, the delivery vessel 12 should travel the larger part of the distance between the export terminal and the import terminal, leaving the receiving vessel 14 to travel as short a distance as possible between the ship-to-ship transfer location 16 and a regasification location 22. However, it is to be understood that the receiving vessel 14 can be fitted with a power generation system 24 including a propulsion plant 26 that enables it to travel under its own power across an ocean or sea between an import terminal and an export terminal if required. A key advantage of the use of a self-propelled receiving vessel 14 over a permanently moored offshore storage structure is that the receiving vessel 14 is capable of travelling under its own power offshore or up and down a coastline to avoid extreme weather conditions or to avoid a threat of terrorism or to transit to a dockyard or to transit to another LNG import or export terminal. In this event, the receiving vessel 14 may do so with or without LNG stored onboard during this journey. Similarly, if demand for gas no longer exists at a particular regasification location, the receiving vessel 14 can sail under its own power to another regasification location where demand is higher.

After offloading of the LNG from the delivery vessel 12 to the receiving vessel 14 is complete, the receiving vessel 14 is unmoored and unberthed from the delivery vessel 12 before the receiving vessel 14 travels under its own steam from the ship-to-ship transfer location 16 to a regasification location 22 closer to the shore 60. The delivery vessel 12 travels under its own steam back to an export terminal to pick up its next cargo of LNG drawing power from the delivery vessel power generation system 48.

In the embodiment illustrated in FIGS. 1 to 3, the delivery vessel 12 maintains a set course and is underway at a pre-agreed speed heading directly into the prevailing weather. The receiving vessel 14 comes alongside the delivery vessel 12 by manoeuvring closer to the delivery vessel 12 until the course and speed of the receiving vessel 14 matches the course and speed of the delivery vessel 12. The approach angle between the two vessels generally decreases as the parallel distance between the two vessels decreases with the relative heading angle being nominally 2 to 5 degrees. Either vessel can then perform a heading change to bring the vessels parallel. The propulsion plant 26 of the receiving vessel 14 includes twin screw, fixed pitch propellers 27 with transverse thrusters 28 located both forward and aft or just forward that provides the receiving vessel 14 with mooring and positioning capability. This high level of manoeuvrability is useful during the approach, mooring and unmooring operations or if the receiving vessel 14 transits to a dry dock (not shown).

After the two vessels have completed the approach, the delivery vessel 12 is moored to the receiving vessel 14 using a suitable arrangement of mooring lines 31. The arrangement includes spring lines 32, stern lines 34 and bow lines 36. Transfer of LNG from the delivery vessel 12 to the receiving vessel 14 can be conducted while the two vessels are underway, drifting, or at anchor depending on such relevant factors as the weather, sea currents, the relative sizes of the vessels, the arrangement mooring lines and fenders, the type of manifold configuration that will allow a LNG transfer system 40 to be connected, the motion characteristics in certain sea states and the manoeuvring characteristics. Ballasting devices (not shown) can be used to ensure that the freeboard of the receiving vessel 14 is maintained substantially the same as that of the delivery vessel 12 during LNG transfer operations if desired.

After mooring operations have been completed, LNG from the delivery vessel storage tank(s) 18 is transferred to the receiving vessel storage tank(s) 20. There are four principal types of LNG storage tanks designed for use on an LNG vessel and these are loosely categorized as prismatic self-supporting types or membrane types. The most common type of self-supporting tanks are the spherical aluminium tanks referred to in the art as a “Moss tank” and the prismatic self-supporting tanks developed by Ishikawajima-Harima Heavy Industries (“IHI”). The most well known types of membrane tank are the TGZ Mark III developed by Technigaz which includes a stainless steel membrane with ‘waffles’ to absorb the thermal contraction when the tank is cooled down, and the GT NO96 developed by Gaz Transport which consists of a primary and secondary thin membranes made of the iron-nickel alloy FeNi36, which has almost no thermal contraction. The insulation is constructed of plywood boxes filled with a lightweight insulating material such as perlite.

In a preferred embodiment, the receiving vessel 14 has a supporting hull structure 44 capable of withstanding the loads imposed from intermediate filling levels when the receiving vessel 14 is subject to harsh, multi-directional environmental conditions. The receiving vessel storage tank(s) 20 are designed to be robust to or reduce sloshing of the LNG when the receiving vessel storage tanks 20 are partly filled or when the receiving vessel 14 is riding out a storm whilst positioned at a regasification location 22 whilst transferring natural gas to an onshore gas distribution facility 46. To reduce the effects of sloshing, the receiving vessel storage tank(s) 20 can be provided with a plurality of internal baffles and/or a reinforced membrane, for example, SPB type B membrane tanks. Self supporting spherical cryogenic storage tanks, for example Moss type tanks, are not considered to be suitable if the receiving vessel 14 is fitted with an onboard regasification facility 30, as Moss tanks reduce the area available to position the regasification facility 30 on the deck 56 of the receiving vessel 14.

It is preferable to empty the delivery vessel 12 in a single ship-to-ship transfer operation. The holding capacity of the receiving vessel storage tank(s) 20 may be the same, similar to or greater than the holding capacity of the delivery vessel storage tank(s) 18, so that the entire payload of LNG onboard the delivery vessel 12 can be transferred to the receiving vessel 14. It is equally possible for the holding capacity of the receiving vessel storage tank(s) 20 to be greater than the holding capacity of the delivery vessel storage tank(s) 18. In this scenario, the receiving vessel 14 may receive LNG from more than one delivery vessel 12. In one embodiment, the receiving vessel 14 is provided with 4 or 7 storage tanks, each receiving vessel storage tank 20 having a gross storage capacity in the range of 30,000 to 50,000 m³. Thus transfer volumes are in the range of 125,000-220,000 m³ depending on the relative size of the storage tanks onboard the two vessels. There is no need for the delivery vessel storage tanks 18 to be designed to be robust to sloshing but this is considered advantageous to better withstand the forces generated as the level of LNG in the delivery vessel storage tank(s) 18 is reduced during the ship-to-ship transfer.

Ship-to-ship transfer of LNG from the delivery vessel 12 to the receiving vessel 14 is conducted using any suitable LNG transfer system 40. To avoid pulling a vacuum during transfer of LNG from the delivery vessel storage tank 18 to the receiving vessel storage tank 20, the system of the present invention includes a return line 42 for transferring boil off gas from the receiving vessel storage tank 20 to the delivery vessel storage tank 18. The return line 42 can be separate from or integrated with the LNG transfer system 40. By way of example, one suitable system for offshore transfer of LNG is described in U.S. Pat. No. 6,637,479, which system comprises a coupling head mounted at one end of a flexible pipe means and arranged for attachment on a platform at one end of one vessel when it is not in use, and a connection unit mounted at one end of the other vessel and comprising a pull-in funnel shaped for guided pull-in of the coupling head to a locking position in which the pipe means can be connected to transfer pipes on the other vessel via a valve means arranged in the coupling head. The coupling head is provided with a guide means and is connected to at least one pull-in wire for guided pull-in of the coupling head into the connection unit by a winch means on the other vessel. The LNG transfer system of U.S. Pat. No. 6,637,479 is constructed and dimensioned for a normal rate of transfer of 10,000 m³ LNG per hour via a flexible pipe or other LNG transfer means mounted on the quarter-deck of the LNG vessel. Because of the fact that the primary couplers will be subjected to strong icing at the extremely low temperature (−163° C.) in the cryogenic transfer, it is desirable to have an emergency disconnection system ensuring quick disconnection of in an emergency situation.

The LNG transfer system 40 and return line 42 can be provided on either the delivery vessel 12 or the receiving vessel 14. During transfer of the LNG from the delivery vessel 12 to the receiving vessel 14, the transfer rate is initially set at a slow rate until it is confirmed that flow has been established without leaks, with the transfer rate then being increased to a higher rate.

Using the process and system of the present invention, the boil off gas generated during ship-to-ship transfer of LNG at sea as the LNG being transferred from a delivery vessel storage tank 18 to a receiving vessel storage tank 20 is managed. Boil off gas is generated due to one or more of the following: a) cooling down of the interior surfaces of the storage tank of the receiving vessel; b) heat leaking in from the environment through the exterior surfaces of the storage tank of the receiving vessel; c) heat from the cryogenic pumps used to transfer the LNG from the delivery vessel to the receiving vessel; and d) heat ingress from the transfer hoses or loading arms used to transfer the LNG from the delivery vessel to the receiving vessel; and e) flashing off due to a temperature increase during the transfer operation.

As stated above under the heading of “Background to the Present Invention”, it is standard practice in the art for the boil off gas generated in the cryogenic storage tanks onboard a prior art traditional LNG carrier to be removed on a continuous basis to avoid any increase in pressure within the cryogenic storage tank (which would lead to a simultaneous increase in the temperature due to the phenomenon known as “autorefrigeration”). Using prior art methods, the boil off gas is removed and then re-liquefied or vented or burned to ensure that a steady state pressure and temperature within the cryogenic storage tanks is maintained at all times.

In contrast, the receiving vessel storage tanks 20 of the present invention are specifically designed to operate at a pressure greater than the operating pressure of the delivery vessel storage tanks 18. As a consequence of not removing the boil off gas generated in the receiving vessel storage tanks 20, the pressure and temperature of the LNG stored in the receiving vessel storage tanks 20 is higher than the pressure and temperature of LNG stored onboard a standard LNG carrier. The receiving vessel storage tank(s) 20 are specifically designed to tolerate the higher pressure and temperature whilst still complying with all relevant international design codes (for example, leak before failure criterion). There is no need for the delivery vessel storage tank(s) 18 to be modified for the purpose of excess boil off gas management.

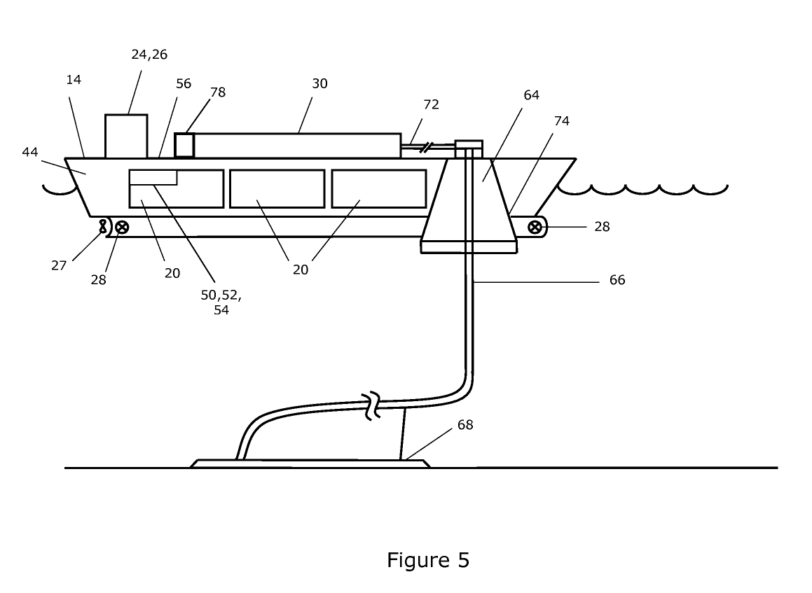

With referenced to FIG. 5, the receiving vessel storage tanks 20 are provided with a tank protection system 50 which includes a pressure monitoring device 52, in the form of a pressure gauge, and a relief valve 54. Using the process of boil off gas management of the present invention, the relief valve of the receiving vessel storage tanks can be set at a pressure of at least 0.2 bar or at least 0.35 bar or at least 0.5 bar above the standard operating pressure of the delivery vessel storage tank 18, for example 0.2 to 0.65 bar above atmospheric. The upper limit of the relief valve pressure can be set at 0.7 bar above atmospheric pressure. The receiving vessel storage tank(s) 20 and the delivery vessel storage tank(s) 18 both have a standard operating pressure in the range of atmospheric pressure up to 0.15 bar above atmospheric. Thus, by way of example, if the delivery vessel storage tank 18 was operating at a standard operating pressure of atmospheric pressure, the relief valve of the receiving vessel storage tank 20 can be set at a pressure of at least 0.2 bar or at least 0.35 bar or at least 0.5 bar above atmospheric pressure. If, however, the delivery vessel storage tank 18 was operating at a standard operating pressure of 0.15 bar above atmospheric pressure, the relief valve of the receiving vessel storage tank 20 can be set at a pressure of at least 0.35 bar or at least 0.5 bar or at least 0.65 bar above atmospheric pressure.

In order to avoid pulling a vacuum whilst the LNG from delivery vessel storage tanks 18 is being transferred to the receiving vessel storage tanks 20, a portion of the boil off gas generated in the receiving vessel storage tanks 20 is transferred to the delivery vessel storage tanks 18 using the return line 42.

If desired, a portion of the excess boil off gas stored in the receiving vessel storage tanks 20 is used as a source of fuel for the receiving vessel power generation system 24 after the ship to ship transfer has been completed, for example, as the receiving vessel 14 travels from the ship-to-ship transfer location 16 towards the onshore gas distribution facility 46. Similarly, if desired, a portion of the boil off gas sent back to the delivery vessel 12 through the return line 42 can be used as a source of fuel for the delivery vessel power generation system 48 whilst the two vessels are moored together during ship to ship transfer.

In one embodiment of the present invention, the receiving vessel 14 is provided with an onboard regasification facility 30 and the LNG stored onboard the receiving vessel 14 is regasified onboard the receiving vessel 14 to form natural gas (NG) which is then transferred to an onshore gas distribution facility 46. With reference to the embodiment illustrated in FIG. 5, the natural gas that is produced in the regasification facility 30 provided onboard the receiving vessel 14 is transferred via a gas delivery line 72 to a turret mooring buoy 64 located at the regasification location 22. A flexible marine riser(s) 66 (best seen in FIG. 5) is used to transfer natural gas from the regasification facility 30 to the onshore gas distribution facility 46. A marine riser(s) 66 is fluidly connected at its upper end to the turret mooring buoy 64 and is fluidly connected at its lower end to a sub-sea pipeline(s) 68 that travels across to a beach crossing 70 to the onshore gas distribution facility 46.

The excess boil off gas pressure which is allowed to build up in the receiving vessel storage tank(s) 20 is reduced to normal operating levels during regasification operation. Alternatively, the excess boil off gas stored in the receiving vessel storage tank 20 during ship to ship transfer can be recompressed and discharged with the gas sent out to the onshore gas distribution facility 46 through the sub-sea pipeline 68. In one embodiment of the present invention, the receiving vessel 14 is provided with an onboard reliquefaction plant 78 for forming LNG from boil-off gas to reduce the pressure in the receiving vessel storage tank 20 after ship-to-ship transfer of LNG. As a fail-safe, the receiving vessel 14 is provided with a gas combustion unit (not shown) to burn boil off gas in the event of failure of the power generation equipment 24.

Now that several embodiments of the invention have been described in detail, it will be apparent to persons skilled in the relevant art that numerous variations and modifications can be made without departing from the basic inventive concepts. All such modifications and variations are considered to be within the scope of the present invention, the nature of which is to be determined from the foregoing description and the appended claims.

All of the patents cited in this specification, are herein incorporated by reference. It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A process for managing boil-off gas generated during ship-to-ship transfer of LNG at sea, the process including the steps of:
(a) transferring LNG from a storage tank onboard a self-propelled delivery vessel to a storage tank onboard a self-propelled receiving vessel at a ship-to-ship transfer location whilst operating the receiving vessel storage tank at a pressure greater than the operating pressure of the delivery vessel storage tank;
(b) returning a sufficient portion of the boil-off gas from the receiving vessel storage tank to the delivery vessel storage tank to avoid pulling a vacuum; and,
(c) reducing the pressure within the receiving vessel storage tank to a normal operating pressure during regasification of LNG to produce natural gas when the self-propelled receiving vessel transits from the ship-to-ship transfer location to a regasification location closer to shore.

2. The process according to claim 1 wherein the receiving vessel storage tank is provided with a tank protection system which includes a pressure monitoring device and a relief valve.

3. The process according to claim 2 wherein the delivery vessel storage tank has a standard operating pressure in the range of 0 to 0.15 bar above atmospheric pressure and the relief valve provided on the receiving vessel storage tank is set at 0.2 bar above the standard operating pressure of the delivery vessel storage tank.

4. The process according to claim 2 wherein the delivery vessel storage tank has a standard operating pressure in the range of 0 to 0.15 bar above atmospheric pressure and the relief valve provided on the receiving vessel storage tank is set at 0.35 bar above the standard operating pressure of the delivery vessel storage tank.

5. The process according to claim 2 wherein the delivery vessel storage tank has a standard operating pressure in the range of 0 to 0.15 bar above atmospheric pressure and the relief valve provided on the receiving vessel storage tank is set at 0.5 bar above the standard operating pressure of the delivery vessel storage tank.

6. The process according to claim 2 wherein the relief valve provided on the receiving vessel storage tank is set at 0.7 bar above atmospheric pressure.

7. The process according to claim 1 wherein the receiving vessel storage tank is self-supporting, or membrane or prismatic tank.

8. The process according to claim 1 wherein the receiving vessel has a power generation system and a portion of the boil off gas from the receiving vessel storage tank is used as a source of fuel for the power generation system of the receiving vessel after the ship to ship transfer has been completed.

9. The process according to claim 1 wherein the delivery vessel has a power generation system and a portion of boil off gas being transferred from the receiving vessel storage tank to the delivery vessel storage tank is used as a source of fuel for the delivery vessel power generation system during ship to ship transfer.

10. A system for managing boil-off gas generated during ship-to-ship transfer of LNG at sea, the LNG being transferred from a storage tank onboard a self-propelled delivery vessel to a storage tank onboard a self-propelled receiving vessel, the system comprising:
a receiving vessel storage tank arranged to operate at a pressure greater than the operating pressure of the delivery vessel storage tank;
a return line for transferring a sufficient portion of the boil-off gas from the receiving vessel storage tank to the delivery vessel storage tank to avoid pulling a vacuum; and,
a regasification facility onboard the self-propelled receiving vessel for reducing the pressure within the receiving vessel storage tank to a normal operating pressure during regasification of LNG to produce natural gas when the self-propelled receiving vessel transits from the ship-to-ship transfer location to a regasification location closer to shore.

11. The system according to claim 10 wherein the receiving vessel storage tank is provided with a tank protection system which includes a pressure monitoring device and a relief valve.

12. The system according to claim 11 wherein the delivery vessel storage tank has a standard operating pressure in the range of 0 to 0.15 bar above atmospheric pressure and the relief valve provided on the receiving vessel storage tank is set at 0.2 bar above the standard operating pressure of the delivery vessel storage tank.

13. The system according to claim 11 wherein the delivery vessel storage tank has a standard operating pressure in the range of 0 to 0.15 bar above atmospheric pressure and the relief valve provided on the receiving vessel storage tank is set at 0.35 bar above the standard operating pressure of the delivery vessel storage tank.

14. The system according to claim 11 wherein the delivery vessel storage tank has a standard operating pressure in the range of 0 to 0.15 bar above atmospheric pressure and the relief valve provided on the receiving vessel storage tank is set at 0.5 bar above the standard operating pressure of the delivery vessel storage tank.

15. The system according to claim 11 wherein the relief valve provided on the receiving vessel storage tank is set at 0.7 bar above atmospheric pressure.

16. The system according to claim 10 further comprising LNG transfer equipment and wherein the return line is integrated with the LNG transfer equipment.

17. The system according to claim 10 wherein the receiving vessel has a power generation system and a portion of the boil off gas from the receiving vessel storage tank is used as a source of fuel for the power generation system of the receiving vessel after the ship to ship transfer has been completed.

18. The system according to claim 10 wherein the delivery vessel has a power generation system and a stream of boil off gas from the receiving vessel storage tank is used as a source of fuel for the power generation system of the delivery vessel during ship to ship transfer.

19. The system according to claim 10 wherein the receiving storage tank either eliminates sloshing or is robust to sloshing of the LNG when the storage tank is partly filled.

20. The system according to claim 19 wherein the receiving vessel storage tank is a self-supporting or a prismatic or a membrane tank.

21. The system according to claim 20 wherein the onboard regasification facility uses ambient air as a source of heat.

22. The system according to claim 21 wherein the LNG is regasified through heat exchange with an intermediate fluid and the intermediate fluid is heated using ambient air as a source of heat to the onboard regasification facility.

23. The system according to claim 21 wherein heat exchange between the ambient air and the LNG or between ambient air and an intermediate fluid is encouraged through use of forced draft fans.

24. The system according to claim 10 wherein the receiving vessel further comprises an onboard reliquefaction plant for forming LNG from a portion of the boil-off gas to reduce the pressure in the receiving vessel storage tank after ship-to-ship transfer of LNG.
